(19) United States
(12) Patent Application Publication
(10) Pub. No.: US 2019/0346333 A1
(43) Pub. Date: Nov. 14, 2019

(54) SYSTEMS AND METHODS OF IN-PIPE ROBOT LOCALIZATION

(71) Applicant: Massachusetts Institute of Technology, Cambridge, MA (US)

(72) Inventors: Kamal Youcef-Toumi, Cambridge, MA (US); You Wu, Cambridge, MA (US); Elizabeth Mittmann, Palo Alto, CA (US)

(21) Appl. No.: 16/408,204

(22) Filed: May 9, 2019

Related U.S. Application Data
(60) Provisional application No. 62/669,147, filed on May 9, 2018.

(51) Int. Cl. G01M 3/18; F17D 5/06

(52) U.S. Cl. CPC G01M 3/183; F17D 5/06

(57) ABSTRACT

Systems and methods are provided to localize a robot in a water pipe system or other fluid conduit based in part on obtrusions detected by the robot travelling through the system. The obtrusions can include pipe joints that connect consecutive standard fixed-length pipe segments. By detecting such repeating obtrusions, the robot can estimate its speed and/or the relative distance that it has travelled within the pipe system. The robot can be configured to localize itself by detecting consecutive pipe joints and other obtrusions in the pipe system using low cost, non-conventional on-board tactile sensors.

### RELATED APPLICATIONS

This application claims the benefit of U.S. Provisional Patent Application No. 62/669,147, filed on May 9, 2018, the contents of which is incorporated herein by reference in its entirety.

### FIELD

The present disclosure relates to systems and methods for localizing a robot within a water pipe system or other fluid conduit, and more particularly to systems and methods for localizing a robot by detecting pipe joints and/or other obtrusions within the pipe system or other fluid conduit.

### BACKGROUND

In robotic missions for water pipelines, knowing the location of the robot is important, yet it is a hard problem to address. If the location of the robot is not known with good accuracy, then the in-pipe mission can be a failure. For example, if the robot is supposed to create a map of the pipe but it doesn't know where it is, then the pipe map cannot be created.

Typically, an extensive network of wireless sensors is set-up for locating the robot inside an underground pipe. However, due to attenuation of wireless signals through the ground, locating the in-pipe robot with outside-the-pipe sensors can be difficult, power intensive, and costly.

Conventional on-board sensors, such as wheel encoders and cameras, can be used to estimate a robot's speed and distance. However, such sensors are generally ineffective at measuring speed and distance when used in an operating water pipe. For example, wheel encoders can slip, and cameras can have low visibility.

In some pipeline applications, such as underground water distribution pipelines, existing pipe maps may be inaccurate. Additionally, real-time information on pipe flow speeds is generally unknown. For example, the flow rate throughout a water pipe often varies and sometimes diminishes due to active water usage. Given such constraints, it can be difficult to make certain assumptions for localizing a robot that require the availability of accurate pipe maps and/or access to real time flow speed knowledge.

Therefore, there is a need for systems and methods of accurately localizing a robot within a water pipe system or other fluid conduit.

### SUMMARY

Water pipe systems are generally constructed by connecting standard straight pipe segments of a fixed, or substantially fixed, length. When consecutive pipe segments are joined together, the pipe joint can form an obtrusion. The obtrusion can be, for example, an O-ring that seals the connection in some polyvinyl chloride (PVC) pipes, or the backside of a groove in some cast iron pipes. Such obtrusions commonly repeat along a length of the pipe at fixed intervals.

Because the distance between pipe joints in a water pipe system is typically fixed, one may think that a robot can simply count the pipe joints and estimate its average speed and distance travelled as it moves through the pipe system. However, counting pipe joints is not easy in practice. Pipe joints are obtrusions, but not all obtrusions detected by the robot as are necessarily pipe joints. For example, other obtrusions in a water pipe system can include, without limitation, ball valves, gate valves, and tuberculations. The distance between such obtrusions is generally different from the fixed length of a pipe segment and can vary. Thus, if a robot overestimates the number of joints it has passed, its estimate of the speed and distance travelled through the pipe system can be erroneous.

The present disclosures provide systems and methods to localize a robot in a water pipe system or other fluid conduit based in part on obtrusions detected by the robot travelling through the system. In some embodiments, the obtrusions can include pipe joints that connect consecutive standard fixed-length pipe segments. By detecting such repeating obtrusions, the robot can estimate its speed and/or the relative distance that it has travelled within the pipe system. In some embodiments, the robot can be configured to localize itself by detecting consecutive pipe joints and other obtrusions in the pipe system using low cost, non-conventional on-board tactile sensors.

In one exemplary embodiment, a method of locating a robot in a conduit includes obtaining acceleration data of a robot travelling through a conduit, obtaining timestamps associated with a plurality of obtrusions detected in the conduit by the robot, and identifying one or more groups of consecutive obtrusions among the plurality of obtrusions detected in the conduit. Each of the one or more groups of consecutive obtrusions includes a plurality of consecutive obtrusions having substantially equal time delays between them. The method further includes determining an average speed of the robot between the plurality of consecutive obtrusions in each of the one or more groups, and determining a plurality of instantaneous speed values of the robot between the plurality of consecutive obtrusions in each of the one or more groups based on the acceleration data of the robot and the average speed of the robot between the plurality of consecutive obtrusions in each group. The method still further includes determining a distance traveled by the robot by integrating the plurality of instantaneous speed values.

The one or more groups of consecutive obtrusions detected in the conduit can include a first group of consecutive obtrusions and a second group of consecutive obtrusions. In some such embodiments, the method can further include determining a plurality of instantaneous speed values of the robot between the first group of consecutive obtrusions and the second group of consecutive obtrusions based on the acceleration data, a first instantaneous speed value of the robot determined at an end of the first group, and a second instantaneous speed value determined at a beginning of the second group, and determining a distance traveled by the robot between the end of the first group of consecutive obtrusions and the beginning of the second group of consecutive obtrusions by integrating the plurality of instantaneous speed values of the robot determined between the first group and the second group.

In some embodiments that include a first group of consecutive obtrusions and a second group of consecutive obtrusions, the method can include measuring a discrete instantaneous speed value of the robot at each of the plurality of obtrusions detected in the conduit, and determining a plurality of instantaneous speed values of the robot between the first group of consecutive obtrusions and the second group of consecutive obtrusions based on the acceleration data, a first discrete instantaneous speed value of the robot measured at an end of the first group, and a second discrete instantaneous speed value of the robot measured at a beginning of the second group, and one or more discrete instantaneous speed values measured at one or more obtrusions detected between the first group and the second group.

The conduit can be a water pipe system, and the plurality of consecutive obtrusions can be consecutive pipe joints disposed between consecutive pipe segments that can have a substantially fixed length. In some such embodiments, determining the average speed of the robot between the plurality of consecutive obtrusions in each of the one or more groups can include dividing the substantially fixed length of the consecutive pipe segments by a time delay measured between one or more pairs of the consecutive pipe joints in each group.

The method can include detecting the plurality of obtrusions in the conduit using a tactile sensor that is associated with the robot. In some embodiments, the method can include measuring a discrete instantaneous speed value of the robot at each of the plurality of obtrusions in the conduit, and determining the plurality of instantaneous speed values of the robot between the plurality of consecutive obtrusions in each of the one or more groups based on the acceleration data, the average speed of the robot determined between the plurality of consecutive obtrusions in each group, and the discrete instantaneous speed value measured at each of the plurality of consecutive obtrusions in each group.

The method can include obtaining directional data of the robot travelling through the conduit, and determining a location of the robot in the conduit based on the directional data and the determined distance travelled by the robot.

In one exemplary embodiment of a system of locating a robot in a conduit, the system includes a robot configured to travel through a conduit, at least one tactile sensor associated with the robot travelling through a conduit, and a processor coupled to the sensor. The processor is configured to obtain acceleration data of a robot travelling through the conduit, obtain timestamps associated with a plurality of obtrusions detected in the conduit by the robot, and identify one or more groups of consecutive obtrusions among the plurality of obtrusions detected in the conduit. Each of the one or more groups includes a plurality of consecutive obtrusions having substantially equal time delays between them. The processor is also configured to determine an average speed of the robot between the plurality of consecutive obtrusions in each of the one or more groups, and determine a plurality of instantaneous speed values of the robot between the plurality of consecutive obtrusions in each of the one or more groups based on the acceleration data and the average speed of the robot between the plurality of consecutive obtrusions in each group. Still further, the processor is configured to determine a distance traveled by the robot by integrating the plurality of instantaneous speed values.

The one or more groups of consecutive obtrusions detected in the conduit can include a first group of consecutive obtrusions and a second group of consecutive obtrusions. In some such embodiments, the processor can be further configured to determine a plurality of instantaneous speed values of the robot between the first group of consecutive obtrusions and the second group of consecutive obtrusions based on the acceleration data, a first instantaneous speed value of the robot determined at an end of the first group, and a second instantaneous speed value determined at a beginning of the second group, and determine a distance traveled by the robot between the end of the first group of consecutive obtrusions and the beginning of the second group of consecutive obtrusions by integrating the plurality of instantaneous speed values of the robot determined between the first group and the second group.

In some embodiments that include a first group of consecutive obtrusions and a second group of consecutive obtrusions, the processor can be further configured to measure a discrete instantaneous speed value of the robot at each of the plurality of obtrusions detected in the conduit, and determine a plurality of instantaneous speed values of the robot between the first group of consecutive obtrusions and the second group of consecutive obtrusions based on the acceleration data, a first discrete instantaneous speed value of the robot measured at an end of the first group, and a second discrete instantaneous speed value of the robot measured at a beginning of the second group, and one or more discrete instantaneous speed values measured at one or more obtrusions detected between the first group and the second group.

The processor can be further configured to measure a discrete instantaneous speed value of the robot at each of the plurality of obtrusions in the conduit, and determine the plurality of instantaneous speed values of the robot between the plurality of consecutive obtrusions in each of the one or more groups based on the acceleration data, the average speed of the robot determined between the plurality of consecutive obtrusions in each group, and the discrete instantaneous speed value measured at each of the plurality of consecutive obtrusions in each group.

The conduit can be a water pipe system, and the plurality of consecutive obtrusions can be consecutive pipe joints disposed between consecutive pipe segments that can have a substantially fixed length. In some such embodiments, to determine the average speed of the robot between the plurality of consecutive obtrusions in each of the one or more groups, the processor can be further configured to divide the substantially fixed length of the consecutive pipe segments by a time delay measured between one or more pairs of the consecutive pipe joints in each group.

In some embodiments, the processor can be configured to obtain directional data of the robot travelling through the conduit, and determine a location of the robot in the conduit based on the directional data and the determined distance travelled by the robot.

In one exemplary embodiment of a robot, the robot includes a body portion, at least one tactile sensor disposed on the body portion and configured to detect obtrusions in a conduit, and a processor coupled to the sensor. The processor is configured to obtain acceleration data of a robot travelling through the conduit, obtain timestamps associated with a plurality of obtrusions detected in the conduit by the at least one sensor, and identify one or more groups of consecutive obtrusions among the plurality of obtrusions detected in the conduit. Each of the one or more groups includes a plurality of consecutive obtrusions having substantially equal time delays between them. The processor is also configured to determine an average speed of the robot between the plurality of consecutive obtrusions in each of the one or more groups, and determine a plurality of instantaneous speed values of the robot between the plurality of consecutive obtrusions in each of the one or more groups based on the acceleration data and the average speed of the robot between the plurality of consecutive obtrusions in each group. Still further, the processor is configured to determine a distance traveled by the robot by integrating the plurality of instantaneous speed values.

The one or more groups of consecutive obtrusions detected in the conduit can include a first group of consecutive obtrusions and a second group of consecutive obtrusions. In some such embodiments, the processor can be further configured to determine a plurality of instantaneous speed values of the robot between the first group of consecutive obtrusions and the second group of consecutive obtrusions based on the acceleration data, a first instantaneous speed value of the robot determined at an end of the first group, and a second instantaneous speed value determined at a beginning of the second group, and determine a distance traveled by the robot between the end of the first group of consecutive obtrusions and the beginning of the second group of consecutive obtrusions by integrating the plurality of instantaneous speed values of the robot determined between the first group and the second group.

In some embodiments that include a plurality of group of consecutive obtrusions, the processor can be further configured to measure a discrete instantaneous speed value of the robot at each of the plurality of obtrusions detected in the conduit, and determine a plurality of instantaneous speed values of the robot the plurality of consecutive obtrusions in each of the plurality of groups of consecutive obtrusions based on the acceleration data, the average speed of the robot determined between the plurality of consecutive obtrusions in each group, and the discrete instantaneous speed value measured at each of the plurality of consecutive obtrusions in each group. The processor can also be configured to determine a plurality of instantaneous speed values of the robot between the plurality of groups of consecutive obtrusions based on the acceleration data, a first discrete instantaneous speed value of the robot measured at an end of a first group among the plurality of groups, a second discrete instantaneous speed value of the robot measured at a beginning of a second group among the plurality of groups, and one or more discrete instantaneous speed values measured at one or more obtrusions detected between the first group and the second group.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1A is a schematic, partially transparent side view illustration of one exemplary embodiment of a robot configured to localize itself by detecting obtrusions in an exemplary water pipe system;

FIG. 1B is a detailed, partially transparent side view of the robot and pipe system of FIG. 1A;

FIG. 2 is a schematic illustration of one exemplary embodiment of components of a computing device that may be operated in conjunction with a robot, like the robot of FIG. 1A, for localizing the robot based on obtrusions detected in a water pipe system or other fluid conduit;

FIGS. 3A-3F are exemplary time graphs for illustrating one exemplary embodiment of a method of localizing a robot, like the robot of FIG. 1A, based on obtrusions detected in a water pipe system or other fluid conduit;

FIG. 4A is a schematic, partially transparent side view illustration of another exemplary embodiment of a robot configured to localize itself by detecting obtrusions in an exemplary water pipe system, the robot using at least one pair of series-connected sensors;

FIG. 4B is a perspective top view of the at least one pair of series-connected sensors of FIG. 4A;

FIGS. 5A-5G are exemplary time graphs for illustrating one exemplary embodiment of a method of localizing a robot, like the robot of FIG. 4A, based on obtrusions detected in a water pipe system or other fluid conduit; and

FIG. 6 is a schematic illustration of one exemplary embodiment of an in-pipe leak detection system configured to detect leaks and obtrusions in a pipe, like the robot of FIG. 1A; and

FIG. 7 is a schematic illustration of one exemplary embodiment of a coupling mechanism disposed between some combination of a sensing element and membrane and a support structure, each of the sensing element, membrane, and support structure being from the in-pipe leak detection system of FIG. 6.

### DETAILED DESCRIPTION

Certain exemplary embodiments will now be described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

In the present disclosure, like-numbered and/or like-named components of various embodiments generally have similar features when those components are of a similar nature and/or serve a similar purpose, unless stated otherwise. A person skilled in the art, in view of the present disclosure, will understand various instances in which like-numbered components across various figures are akin. Further, although terms such as “first” and “second” are used to describe various features of the present disclosures, such use is not indicative that one feature comes before the other. Use of terms of this nature may be used to distinguish two similar features, and often such first and second features can be used interchangeably. Additionally, to the extent that terms are used in the disclosure to describe a direction, orientation, and/or relative position, such terms are not intended to be limiting. For example, a person skilled in the art will recognize that terms of direction, orientation, and/or relative position (e.g., top, bottom, left, right, above, below, etc.) can be used interchangeably depending, at least in part, on the perspective of the operator.

The present disclosures provide systems and methods to localize a robot in a water pipe system or other fluid conduit based in part on obtrusions detected by the robot travelling through the system. In some embodiments, the obtrusions can include pipe joints that connect consecutive standard fixed-length pipe segments. By detecting such repeating obtrusions, the robot can estimate its speed and/or the relative distance that it has travelled within the pipe system. In some embodiments, the robot can be configured to localize itself by detecting consecutive pipe joints and other obtrusions in the pipe system using low cost, non-conventional on-board tactile sensors.

In some embodiments, the systems and methods provided herein can enable the robot to determine its speed and location at any point of time in a water pipe system with an accuracy approximately in a range between about 1 meter to about 3 meters, thereby avoiding the need to rely upon pipe maps or flow speed references. In some embodiments, the systems and methods for in-pipe robot localization provided herein can be performed without the need for on-board or remote devices, such as wheel encoders, cameras, wireless sensor networks, and/or a Global Positioning System (GPS). In some instances, nevertheless, one or more of these types of features can be incorporated or otherwise used in conjunction with the novel configurations provided for herein.

Although the illustrated embodiments provided herein involve water pipe systems, a person skilled in the art will understand how the disclosures provided for herein can be adapted to localize a robot moving through other fluid conduits, including but not limited to oil pipe systems and natural gas pipe systems, for example.

Water pipe systems are generally constructed by connecting standard straight pipe segments of a fixed, or substantially fixed, length (referred to herein as a “fixed length,” although a person skilled in the art will appreciate there may be a slight variation amongst lengths, such as within about ±5%). When consecutive pipe segments are joined together, the pipe joint can form an obtrusion. The obtrusion can be, for example, an O-ring that seals the connection in some polyvinyl chloride (PVC) pipes, or the backside of a groove in some cast iron pipes. Such obtrusions commonly repeat along a length of the pipe at fixed intervals. As discussed in more detail below, the robot can be configured to sense such repeating obtrusions as it moves through the pipe system.

Because the distance between pipe joints in a water pipe system is typically fixed, one may think that a robot can simply count the pipe joints and estimate its average speed and distance travelled as it moves through the pipe system. However, counting pipe joints is not easy in practice. Pipe joints are obtrusions, but not all obtrusions detected by the robot as are necessarily pipe joints. For example, other obtrusions in a water pipe system can include, without limitation, ball valves, gate valves, and tuberculations. The distance between such obtrusions is generally different from the fixed length of a pipe segment and can vary. Thus, if a robot overestimates the number of joints it has passed, its estimate of the speed and distance travelled through the pipe system can be erroneous.

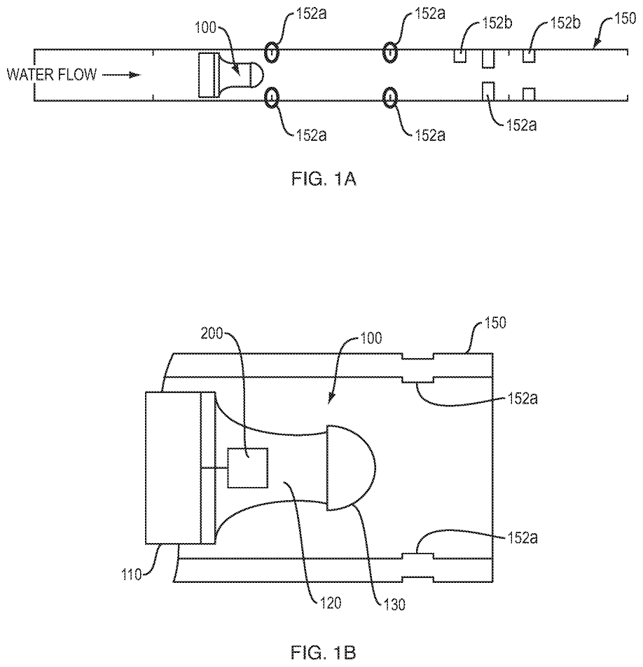

FIGS. 1A and 1B illustrate one exemplary embodiment of a robot 100 configured to localize itself by detecting obtrusions in an exemplary water pipe system 150. As shown, the robot 100 can include one or more tactile sensors 110, a soft body portion 120, a rigid end cap 130, and a computing device 200. In some embodiments, the robot 100 can be a passive flow-driven robot or drone that is pushed through the water pipe system 150 by water flow. In other embodiments, the robot 100 can be configured to actively propel itself through the water pipe system 150. The tactile sensors 110 can be disposed at or about a trailing end of the soft body portion 120 and the end cap 130 can be disposed at or about to a leading end of the soft body portion. In other embodiments, the tactile sensors 110 can be disposed elsewhere on the body 120 of the robot 100. The tactile sensors 110 can be coupled to, or otherwise associated with the robot 100 using any number of techniques known to those skilled in the art for associating a sensor with an object, including but not limited to adhering it to the robot 100, coupling it to the robot 100 using any number of mechanisms (e.g., a post, a linkage, any other object that can associate one component with another).

The tactile sensors 110 can be configured to detect obtrusions along the length of the pipe system 150, such as pipe joints 152a and other non-joint obtrusions 152b (e.g., ball valves, gate valves, tuberculations, etc.). The pipe joints 152a can be disposed between standard pipe segments 154 of fixed length. In some embodiments, the tactile sensors 110 can be configured to stretch or compress as they come into contact with an obtrusion 152a or 152b (collectively 152) along the inner wall of the pipe system 150. Further details regarding the structure and operation of an exemplary robot, like the flow-driven robot 100, for detecting obtrusions is described in International Patent Application No. PCT/US2017/056890, filed on Oct. 17, 2017, the contents of which is incorporated herein by reference in its entirety. Persons skilled in the art will recognize that other tactile sensors and/or robotic devices can be used to detect obtrusions in a water pipe system or other fluid conduit.

The computing device 200 can be electrically coupled to the sensors 110 and configured to power and control the operation of the robot 100, including operation of an in-pipe robot localization method as discussed in more detail below. In some embodiments, the computing device can be electrically coupled to the sensors 110 by a wired connection, wireless connection, and/or optical connection, for example. As shown in the illustrated embodiment, the computing device 200 can be embedded or otherwise integrated inside the soft body portion 120 of the robot 100. However, persons skilled in the art will recognize that the computing device 200 can be incorporated into the robot in a variety of other ways.

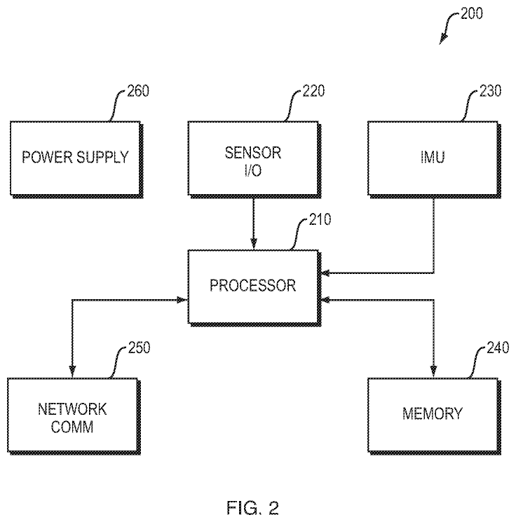

FIG. 2 illustrates one exemplary embodiment of components of a computing device 200 that may be operated in conjunction with a robot, like the robot of FIG. 1A, for localizing the robot based on obtrusions detected in a water pipe system or other fluid conduit. With reference to FIGS. 1A-2, the computing device 200 can include various circuits and other electronic components used to power and control the operation of the robot 100. For example, in the illustrated embodiment, the computing device 200 can include a processor 210, a sensor input/output (I/O) processor 220, an inertial measurement unit (IMU) 230, memory 240, a network communications processor 250, and a power supply 260.

In some embodiments, the processor 210 can be configured to implement methods of localizing a robot 100 within a pipe system 150 or other fluid conduit based on the outputs of the sensor I/O processor 220, the IMU 230, memory 240, or any combination thereof. In some embodiments, the processor 210 can be any programmable microprocessor, microcomputer, microcontroller, or multiple processor chip or chips that can be configured by software instructions (e.g., applications) to perform a variety of functions. The software instructions and/or software applications can be stored in the memory 240 before they are accessed and loaded into the processor 210. The processor 210 can additionally or alternatively include internal memory sufficient to store such software instructions and/or applications.

The memory 240 can store processor-executable instructions. The memory 240 can also store data measured, estimated, or otherwise manipulated by the processor 210 from sensor I/O processor 220 and/or IMU 230. The memory 240 can be volatile memory (e.g., random access memory or RAM), non-volatile memory (e.g., flash memory), or a combination thereof The memory 240 can include internal memory included in the processor 210, memory external to the processor 210, or any combination thereof In some embodiments, the processor 210 may store the output data from one or more of the sensor I/O processor 220, the IMU 230, and the processor itself in the memory 240 for subsequent access by a remote computing device (e.g., computer, mobile device, etc.). A remote computing device (not shown) can be configured to utilize the results and/or intermediate data of the localization methods provided herein, e.g., for creating maps of the pipe system or fluid conduit, identifying location of fluid leaks in the pipe system, and/or other use(s) in a post-processing operation.

In some embodiments, the sensor I/O processor 220 can be electrically coupled to the tactile sensors 110 disposed on robot 100 and configured to receive sensor output data for detecting obtrusions in the pipe system 150. In some embodiments, the processor 210 itself can be coupled directly to the sensors 110 and configured to detect obtrusions in the pipe system based on the output data from the sensors. Further details regarding methods for detecting obtrusions in a pipe system (e.g., false fluid leaks and/or obstacles), and the computing devices and systems that can be set-up to help evaluate or otherwise perform the same, is described in International Patent Application No. PCT/US2017/056890, filed on Oct. 17, 2017, the contents of which was previously incorporated by reference above. A person skilled in the art, in view of the present disclosures, would be able to apply the disclosures provided for herein related to detecting a location of a robot to any number of computing devices, systems, etc. without departing from the spirit of the present disclosure.

The IMU 230 can be configured to provide acceleration measurements that are indicative of changes or variation in the robot's speed. The IMU 230 can also be used to measure and/or provide directional data that is indicative of a direction that the robot is heading. Directional data can include, without limitation, compass readings (e.g., data indicative of the robot heading in north, south, east, west, or combination thereof) and rotational measurements (e.g. speed and/or angle of the robot performing a yaw, pitch, and/or roll maneuver within the pipe).

The processor 210 can be coupled to a network communications processor 250 to communicate the results and/or any intermediate data of the localization methods provided for herein to a remote computing device (not shown) (e.g., computer, mobile device, etc.). Alternatively, or additionally, in some embodiments the processor can communicate output data from one or more of the sensor I/O processor 220 and the IMU 230 via the network communications processor 250 to the remote computing device. The network communications processor 250 can be a radio frequency (RF) processor configured to wirelessly receive and transmit signals via an antenna from and/or to a remote computing device.

The processor 210, the sensor input/output (I/O) processor 220, the IMU 230, the memory 240, and the network communications processor 250, and any other electronic components of the computing device 200, can be powered by the power supply 260. In some embodiments, the power supply 260 can be a battery, a solar cell, or other type of energy harvesting power supply. Persons skilled in the art, in view of the present disclosures, will understand how to implement the computing device 200, or at least various components thereof, into a robot, like the exemplary flow-driven robot 100 provided herein.

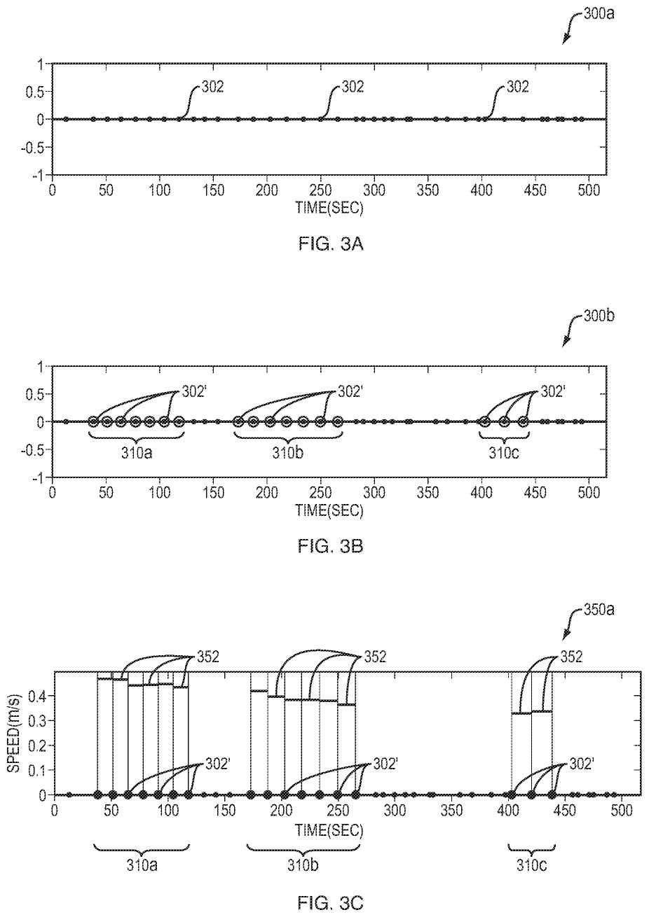

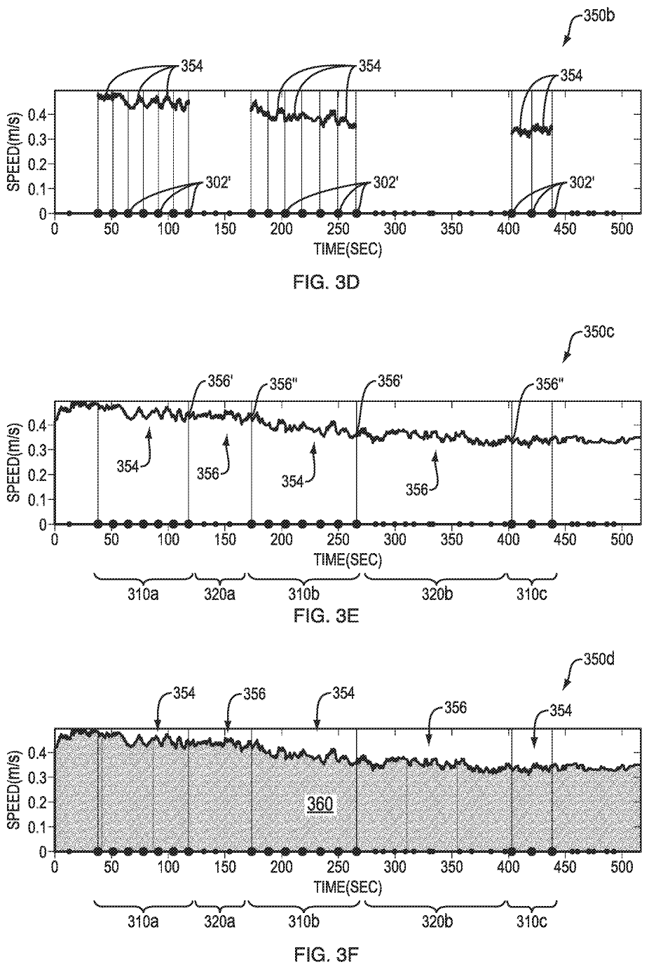

As discussed in greater detail below, the output of the IMU 230 and the tactile sensors 110 can be used the in-pipe robot localization methods provided herein. IMUs, like the IMU 230, can provide acceleration measurements indicative of changes in robot speed. IMUs can also provide directional data indicative of a direction that the robot is heading through rotational speed measurements and compass readings. However, IMUs typically cannot provide reliable estimation on instantaneous robot speed that can be used to estimate the distance travelled by the robot. As discussed below with respect to FIGS. 3A-3F, the instantaneous speed of the robot can be obtained indirectly from one or more tactile sensors 110 that can detect when the robot passes joints or other obtrusions in the pipe system. In any typical water pipe system, a significant portion of the pipe system is made with consecutive standard fixed-length pipe segments. Therefore, the robot can be expected to travel through at least a few zones of consecutive standard fixed-length pipe segments.

FIGS. 3A-3F help illustrate one exemplary embodiment of a method of localizing a robot, like the robot of FIG. 1A, based on obtrusions detected in a water pipe system or other fluid conduit. With reference to FIGS. 1A, 1B, and 2, operations of the method can be performed by a computing device of the robot (e.g., the computing device 200), and particularly a processor (e.g., the processor 210) within the computing device.

Referring to FIG. 3A, the processor 210 can record, or otherwise obtain, data associated with obtrusions detected by the robot 100 travelling through a pipe system 150. For example, as shown in the exemplary time graph 300a, the data can include a series of discrete timestamps 302 (shown as points along the “time” axis). Each of the timestamp 302 can correspond to a specific or relative time when an obtrusion (e.g., the pipe joints 152a of FIG. 1A) was detected by the robot 100. As discussed above, obtrusions can include, without limitation, pipe joints, valves, tuberculations, and/or other structures that can constrict the cross-sectional diameter of a pipe. Additionally, the data obtained by the processor 210 can include acceleration data indicative of speed variations of the robot 100 as it travels through the pipe system 150. In some embodiments, the timestamps 302 and the acceleration data (not shown) can be obtained by recording such data in real-time based on the output of the sensor(s) 110 and/or by accessing such data from the memory 240.

Referring to FIG. 3B, the processor 210 can identify one or more groups of consecutive obtrusions having the same, or substantially the same, time delay between their respective timestamps, although a person skilled in the art will appreciate there may be a slight variation amongst time delays, such as within about ±10% of an average or mean time delay value. For example, in the exemplary time graph 300b, three groups of consecutive obtrusions 310a, 310b, and 310c (collectively 310) are identified among the detected obtrusions. The minimum number of consecutive obtrusions in each group 310 can be equal to three or more consecutive obtrusions, i.e., as identified by their respective timestamps 302′. For example, as shown in the graph 300b, two groups 310a and 310b (sometimes referred to herein as “zones”) include seven (7) consecutive obtrusions 302′ and one group 310c includes three (3) consecutive obtrusions 302′. In some embodiments, the processor 210 can be configured to use signal autocorrelation, Bayesian inference, and/or linear extrapolation to identify groups of consecutive obtrusions having substantially equal time delays between them. Persons skilled in the art will recognize that other algorithms or techniques can also be used to identify groups of consecutive obtrusions.

Referring to FIG. 3C and as indicated above, the consecutive obtrusions in each group 310 can be detected at regular time intervals, e.g., as indicated by their respective timestamps 302′. Thus, the timestamps 302′ identified in each group 310 can be considered to correspond consecutive pipe joints (e.g., pipe joints 152a of FIG. 1A) disposed between fixed length pipe segments (e.g., pipe segments 154 of FIG. 1A). Assuming that the speed of the fluid flowing through the pipe system does not fluctuate significantly over short distances and/or time intervals, the processor 210 can calculate the average speed 352 of the robot between adjacent pairs of consecutive pipe joints by dividing a known length of a standard pipe segment by the time difference between their respective timestamps 302′ (i.e., the time delay for the robot to travel from one joint to the next). In some embodiments, the fixed length of the standard pipe segments used in the pipe system 150 can be obtained from the memory 240. As shown in the exemplary speed versus time graph 350a, the average speed 352 of the robot between adjacent pairs of consecutive pipe joints in each group 310 can vary between different pairs of consecutive pipe joints.

Referring to FIG. 3D, the processor 210 can determine instantaneous speed values 354 of the robot 100 between the consecutive pipe joints, i.e., identified by timestamps 302′. In some embodiments, the instantaneous speed values 354 can be determined based on the acceleration data (not shown) of the robot and the average speed 352 of the robot between consecutive pipe joints (FIG. 3C). For example, as shown in the exemplary speed versus time graph 350b, the instantaneous speed values 354 of the robot between a pair of consecutive pipe joints can be estimated using a data fusion algorithm that combines the average speed values 352 of the robot with the acceleration data of the robot between the joints. In some embodiments, the acceleration data can be provided directly by the IMU 230 and/or from the memory 240.

In some embodiments, an Extended Kalman Filter can be used in combination with a Rauch-Tung-Striebel smoother to estimate the instantaneous speed of the robot by modulating the average speed values 352 between adjacent pairs of consecutive pipe joints 302′ with corresponding acceleration data, thereby reflecting the variations in the speed of the robot between respective joints. Persons skilled in the art will recognize that other data fusion algorithms can also be used. For example, the processor 210 can be configured to use a data fusion algorithm that can: (1) reflect variations in speed of the robot; (2) ensure that the estimated distance traveled from one identified joint to the next is approximately the same as the standard pipe segment length, and/or (3) ensure the speed of the robot at each joint is substantially smooth.

Referring to FIG. 3E, the processor 210 can determine instantaneous speed values 356 of the robot 100 between groups or zones of consecutive pipe joints 310. As shown in the exemplary speed versus time graph 350c, the processor 210 can determine instantaneous speed values 356 in the regions 320a and 320b (collectively 320) that are outside the zones of consecutive joints 310. In some embodiments, the instantaneous speed values 356 in a corresponding region 320 can be determined based on: (i) the instantaneous speed 356′ and 356″ of the robot at the boundaries of the region; and/or (ii) the acceleration data (not shown) of the robot within that region. For example, the beginning instantaneous speed value 356′ can correspond to an instantaneous speed value previously determined at the end of one group of consecutive pipe joints (e.g., group 310a) and the end instantaneous speed value 356″ can correspond to an instantaneous speed value previously determined at the beginning of a next group of consecutive pipe joints (e.g., group 310b).

In some embodiments, the instantaneous speed value 356 of the robot between groups of consecutive pipe joints 310 can be estimated using a data fusion algorithm that can create a substantially smooth instantaneous speed curve (or other geometrical representation) that connects the instantaneous speed values 356′ and 356″ at the boundaries of a corresponding region 320 and modulates the curve with the corresponding acceleration data to reflect the variations in the speed of the robot. For example, the processor 210 can be configured to use an Extended Kalman Filter in combination with a Rauch-Tung-Striebel smoother to determine the instantaneous speed values 356 outside the respective groups of consecutive pipe joints 310. Persons skilled in the art will recognize that other data fusion algorithms can also be used. The acceleration data and the instantaneous speed values at the boundaries of a respective region 320a, 320b can be provided from the memory 240, for example.

Referring to FIG. 3F, the processor 210 can determine a distance 360 traveled by the robot 100 by integrating the instantaneous speed values 354 and/or 356 of the robot over time. For example, as shown in the exemplary graph 350d, the processor can integrate the instantaneous speed values 354 determined in zones 310a, 310b, and 310c and the instantaneous speed values 356 determined in the regions 320a and 320b between the zones 310. In some embodiments, the processor 210 can determine a location of the robot 100 at a given time by integrating the instantaneous speed values 354 and/or 356 up to that given time. For example, in some embodiments, the processor can be used to determine a location of the robot 100 at a given time when the robot detected a leak in the pipe system. In some embodiments, the processor 210 can combine time-specific directional data (e.g., compass data) from the IMU 230 with the distance calculations to create a two-dimensional (2D) or three-dimensional (3D) map of the pipe system 150.

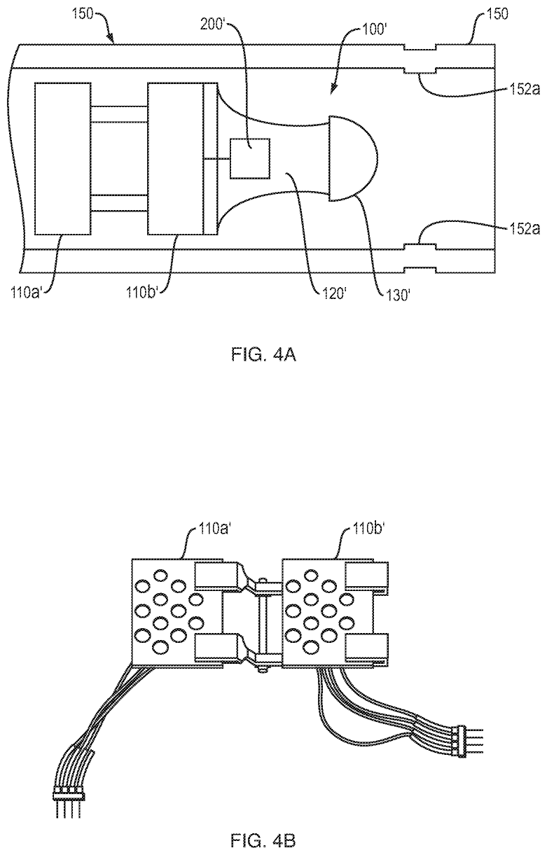

FIGS. 4A and 4B illustrate another exemplary embodiment of a robot 100′ that can be configured to localize itself by detecting obtrusions in a water pipe system or other fluid conduit using at least one pair of series-connected sensors. As shown, the robot 100′ can include at least one pair of tactile sensors 110a′ and 110b′ (collectively 110′) that are connected in series and separated apart by a fixed distance L. The robot 100′ can also include a soft body portion 120′, a rigid end cap 130′, and a computing device 200′. Except as described below, or as will be readily appreciated by a person skilled in the art, the sensors 110′, soft body portion 120′, cap 130′, and the computing device 200′ are the same or substantially the same as the sensors 110, the soft body portion 120, the end cap 130, and the computing device 200 described above. Thus, a detailed description of the structure and function of the robot 100′ is omitted here for the sake of brevity. Further, the details of robots incorporated by reference herein, such as those described in International Patent Application No. PCT/US2017/056890, filed on Oct. 17, 2017, can also be applied to the configuration of the robot 100′.

In some embodiments, the series-connected sensors 110′ of the robot 100′ can be used to take discrete measurements of the instantaneous speed of the robot at each obtrusion identified in the pipe system, thereby improving the localization accuracy of the robot as described herein. For example, in some embodiments, when the robot 100′ passes an obtrusion, each of the tactile sensors 110a′ and 110b′ can output a respective detection signal, i.e., one from each sensor. The time delay dT between the detection signals of the sensors 110′ can be used to measure the instantaneous speed V(t) of the robot at the respective obtrusion according to the equation, V(t)=L/dT.

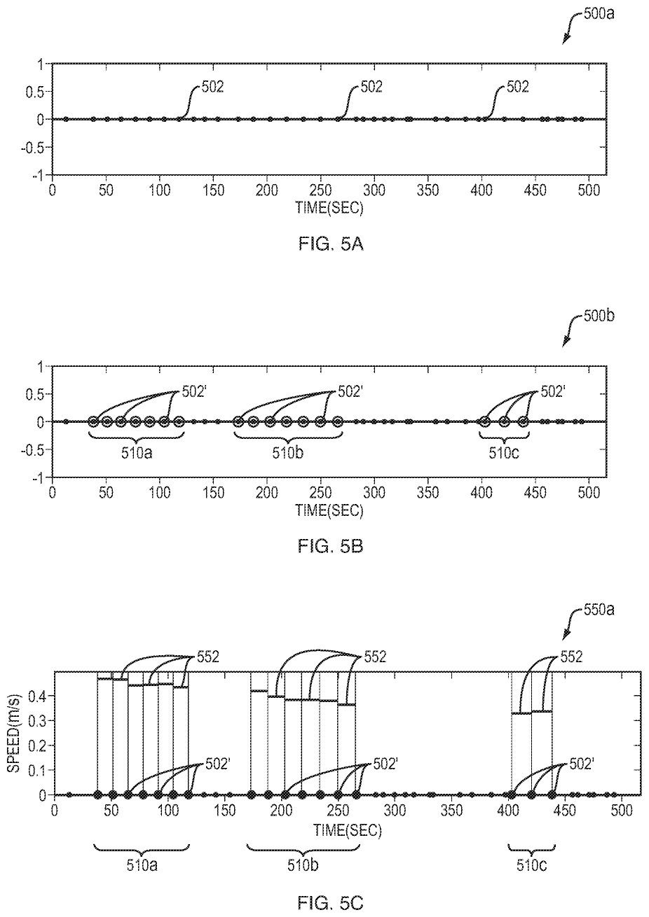

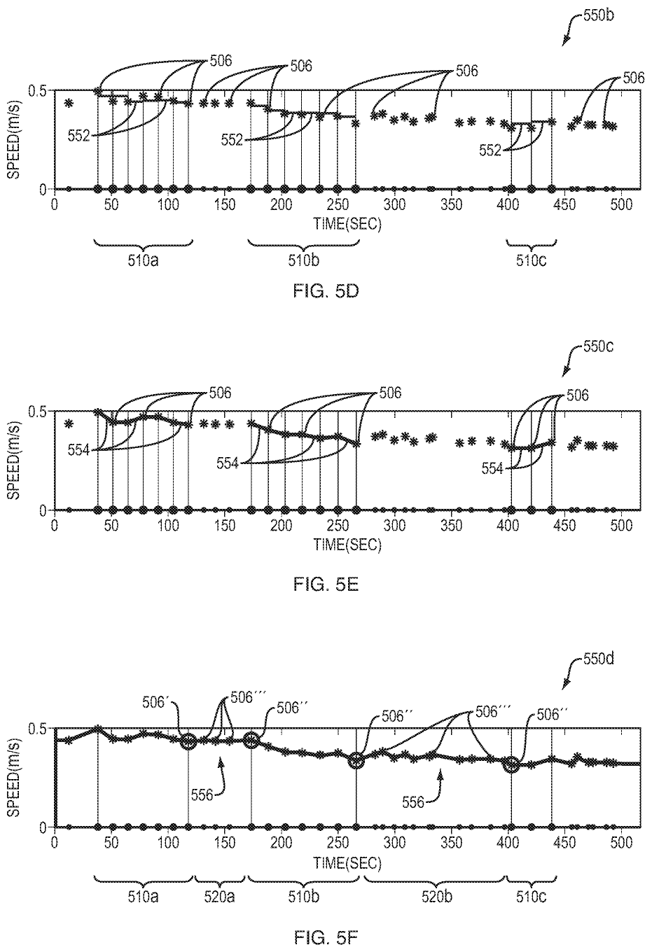

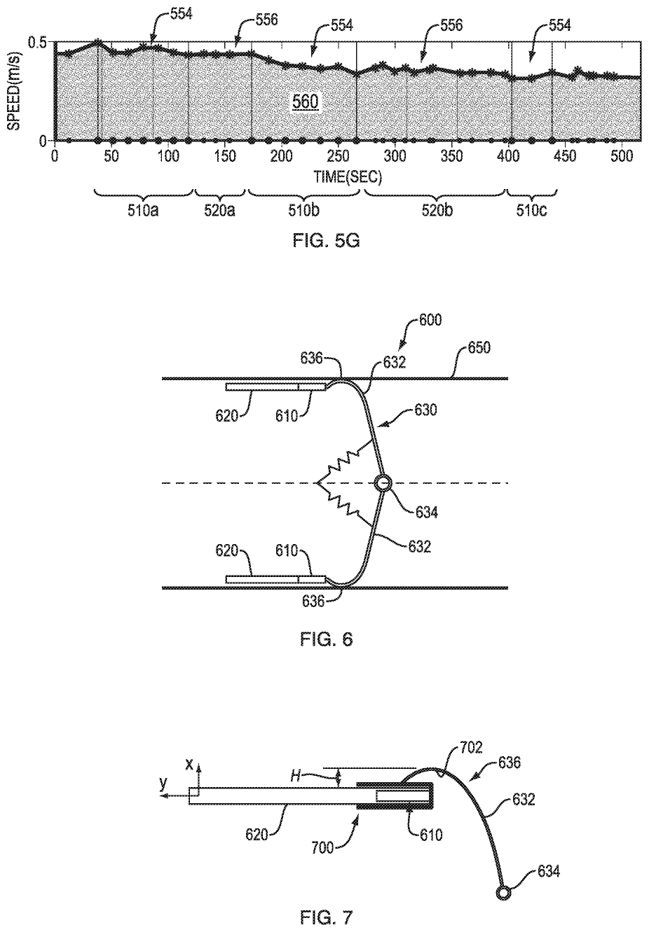

FIGS. 5A-5G help illustrate one exemplary embodiment of a method of localizing a robot, like the robot of FIG. 4A, based on obtrusions detected in a water pipe system or other fluid conduit. With reference to FIGS. 1A, 1B, and 2, operations of the method can be performed by a computing device of the robot (e.g., computing device 200′), and particularly a processor (e.g., processor 210) within the computing device. Except as described below, or as will be readily appreciated by a person skilled in the art, operations described in FIGS. 5A, 5B, and 5C are the same or substantially the same as the operations described above with respect to FIGS. 3A, 3B, and 3C, respectively. Thus, a detailed description of the operations, including the structure and functions thereof, are omitted here for the sake of brevity.

Referring to FIG. 5A, the processor 210 can obtain data associated with obtrusions detected by the robot 100′ as it travels through a pipe system 150 or other fluid conduit. As shown in the exemplary time graph 500a, the data can include a series of discrete timestamps 502 (shown as points along the “time axis”) for each obtrusion detected in the pipe system. As discussed above with respect to FIGS. 4A and 4B, the robot 100′ can include at least one pair of series connected sensors 110′ for detecting obtrusions in the pipe system. Thus, each timestamp 502 can be an average or mean timestamp that indicates when an obtrusion was detected by the sensors 110′. Alternatively, in some embodiments, each timestamp 502 can indicate when an obtrusion was detected by a respective sensor 110a′ or 110b′. Additionally, the data obtained by the processor 210 can include acceleration data indicative of speed variations of the robot 100′ as it travels through the pipe system 150. In some embodiments, the timestamps 502 and the acceleration data (not shown) can be obtained by recording such data in real-time based on the output of the sensors 110′ and/or by accessing such data from the memory 240.

Referring to FIG. 5B, the processor 210 can identify one or more groups of consecutive obtrusions having the same or substantially the same time delay between their respective timestamps. For example, in the exemplary time graph 500b, three groups of consecutive obtrusions 510a, 510b, and 510c (collectively 510) are identified from among the detected obtrusions. As discussed above with respect to FIG. 3B, the minimum number of consecutive obtrusions in each group 510 can be equal to three or more consecutive obtrusions, i.e., as identified by their respective timestamps 502′. In some embodiments, the time difference, or delay, between adjacent pairs of consecutive obtrusions 502′ in each group 510 can be required to be less than a threshold.

Referring to FIG. 5C, and as indicated above, the consecutive obtrusions in each group 510 can be detected at regular time intervals, e.g., as indicated by their respective timestamps 502′. Thus, the timestamps 502′ identified in each group 310 can be considered to correspond to consecutive pipe joints (e.g., pipe joints 152a of FIG. 1A) disposed between fixed length pipe segments (e.g., pipe segments 154 of FIG. 1A). Thus, as shown in the exemplary speed versus time graph 550a, the processor 210 can calculate the average speed 552 of the robot between adjacent pairs of consecutive pipe joints by dividing a known length of a standard pipe segment by the time difference between their respective timestamps 502′ (i.e., the time delay for the robot to travel from one joint to the next).

Referring to FIG. 5D, the processor 210 can additionally measure discrete instantaneous speed values 506 of the robot at each obtrusion detected in the pipe system 150. As discussed above with respect to FIGS. 4A and 4B, when the robot 100′ passes an obtrusion, the series-connected sensors 110a′ and 110b′ can output respective detection signals for the obtrusion, i.e., one from each sensor. Thus, the discrete instantaneous speed values 506 shown in the speed versus time graph 550b can be measured by dividing the fixed separation distance L between the series-connected sensors 110a′ and 110b′ by the measured time difference or delay dT between the detection signals of the sensors 110′ (i.e., V(t)=L/dT).

Referring to FIG. 5E, the processor 210 can estimate the instantaneous speed values 554 of the robot 100′ between the consecutive pipe joints in each group, i.e., as identified by the timestamps 502′. The instantaneous speed values 554 between a pair of consecutive pipe joints can be determined based on: (i) the discrete instantaneous speed values 506 measured at each joint; (ii) the corresponding acceleration data (not shown) between the respective joints; and/or (iii) the average speed value 552 of the robot between the respective joints (FIG. 5D).

In some embodiments, the instantaneous speed values 554 shown in the exemplary speed versus time graph 550c can be estimated using a data fusion algorithm that can create a smooth instantaneous speed curve (or other geometrical representation) that connects the discrete instantaneous speed values 506 measured at the respective pipe joints and modulates the curve based on the average speed value 552 of the robot and the acceleration data of the robot between the respective pipe joints. In some embodiments, the data fusion algorithm can be implemented using an Extended Kalman Filter in combination with a Rauch-Tung-Striebel smoother. Persons skilled in the art will recognize that other data fusion algorithms can also be used that can: (1) reflect variations in the speed of the robot; (2) ensure that the estimated distance traveled from one identified joint to the next is the same as the standard pipe segment length; and/or (3) ensure the speed of the robot at each joint is the same as the measured instantaneous speed.

Referring to FIG. 5F, the processor 210 can determine instantaneous speed values 556 of the robot 100′ in regions between the groups or zones of consecutive pipe joints 510. As shown in the exemplary speed versus time graph 550d, the processor 210 can determine instantaneous speed values 556 in regions 520a and 520b (collectively 520) that are outside the groups of consecutive pipe joints 510. In some embodiments, the instantaneous speed values 556 of the robot in a corresponding region 520 can be determined based on: (i) discrete instantaneous speed values 506′, 506″, and 506′″; and/or (ii) the acceleration data (not shown) of the robot within that region. For example, the instantaneous speed values 506′ and 506″ can correspond to discrete instantaneous speed values measured at the boundaries of a corresponding region 520, and the instantaneous speed values 506′″ can correspond to discrete instantaneous speed values measured at obtrusions detected within the boundaries of that region.

In some embodiments, the instantaneous speed values 556 of the robot within a corresponding region 520 between groups of consecutive pipe joints 510 can be estimated using a data fusion algorithm. The data fusion algorithm can be configured to create a substantially smooth instantaneous speed curve (or other geometrical representation) that connects the discrete instantaneous speed values 506′, 506″, and 506′″ measured within and at the boundaries of the region 520 and modulates the curve with the corresponding acceleration data (not shown). For example, the processor 210 can be configured to use an Extended Kalman Filter in combination with a Rauch-Tung-Striebel smoother to determine the instantaneous speed values 556. Persons skilled in the art will recognize that other data fusion algorithms can also be used that can: (1) create the substantially smooth curve of speed estimation that connects measured instantaneous speed of the robot at all obtrusions; and (2) reflect variations in the speed of the robot.

Referring to FIG. 5G, the processor 210 can determine a distance 560 traveled by the robot 100′ by integrating the instantaneous speed values 554 and/or 556 of the robot over time. For example, as shown in the exemplary graph 550d, the processor can integrate the instantaneous speed values 554 determined in zones of consecutive pipe joints 510a, 510b, and 510c and the instantaneous speed values 556 determined in the regions 520a and 520b between the zones 510, respectively. In some embodiments, the processor 210 can determine a location of the robot 100′ at a given time by integrating the instantaneous speed values 554 and/or 556 up to that given time. For example, in some embodiments, the processor 210 can be used to determine a location of robot 100′ at a given time when the robot detected a leak in the pipe system. In some embodiments, the processor 210 can combine time-specific directional data (e.g., compass data) from the IMU 230 with the distance calculations to create a two-dimensional (2D) or three-dimensional (3D) map of the pipe system.

FIG. 6 is a schematic illustration of one exemplary embodiment of an in-pipe leak detection system 600 configured to detect leaks and obtrusions in a pipe 650. As determinable from additional discussions and descriptions, the illustrated schematic diagram can be considered a cross-section of some of the systems provided for in the present disclosure (e.g., the robot 100 in FIG. 1A). As shown, the system 600 includes sensing elements 610, membranes 620, and a support structure 630. The membranes 620 can be configured to stretch or strain in response to a pulling force on the membrane. For example, when the membrane 620 encounters a leak on the wall of a pipe 650, the pressure gradient at the source of the leak creates a suction force that draws the membrane 620 into contact with the inner wall of the pipe. As the system 600 continues to move in an axial direction of the fluid flow (e.g., left to right in FIG. 6), the friction force of the inner wall pulls against the membrane 620, causing the membrane to stretch and/or strain. Similar to the friction force due to a fluid leak, a friction force caused by the membrane 620 encountering a pipe joint or other obtrusion in the pipe can cause the membrane to stretch in a direction opposite to the axial direction of the fluid flow and the motion of the entire system 600.

To detect the stretch or strain on the membranes, the sensing elements 610 are coupled to the membranes 620. The sensing elements 610 can be force sensors configured to detect a pulling force that stretches the membrane. The sensing elements 610 can alternatively, or additionally, be displacement sensors that detect a strain or deformation of the membrane caused by the pulling force stretching the membrane. For example, the sensing elements 610 can be made of a material having one or more electrical properties (e.g., impedance) correlated to an applied stretch or strain. Accordingly, the stretch or strain on a membrane 620 can be detected by applying the stretch or strain experienced by the membrane to a corresponding sensing element 610 and measuring changes in impedance or other electrical property of the sensing element in response to the applied stretch or strain. In some embodiments, the measured changes in impedance can be converted to a corresponding stretch (force) or strain (displacement) signals according to predetermined relationship or correlation associated with the geometry and material of the sensing element. A person skilled in the art will recognize other types of sensing elements that can be used, as well as other parameters that can be measured, in view of the present disclosures, and use of such sensing elements and parameters does not depart from the spirit of the present disclosure.

When a membrane moves with an active fluid flow, the stretch or strain on the membrane can be characterized as a high frequency input or impulse. To enable the sensing elements 610 to detect such high frequency inputs, the sensing element 610 and the membrane 620 can be disposed substantially parallel to or in-line with an axial direction of a fluid flow in a pipe 650. For example, a sensing element 610 can be embedded or directly coupled to a respective membrane 620 that is disposed substantially parallel to or in-line with an axial direction of the fluid flow. The membrane 620 and the embedded sensing element 610 can be disposed substantially parallel or in-line with the axial direction of the fluid flow by its primary surface (i.e., the surface having a large cross-sectional area) to face a side, quadrant, or other section of the inner pipe wall. Accordingly, by aligning the sensing elements 610 and the membranes 620 with the fluid flow, motions of the sensing elements 610 and the membranes 620 in the axial direction of the flow are minimally hindered by the inertia of the fluid. This allows the sensing elements 610 and the membranes 620 to stretch more easily in the axial direction of the fluid flow and detect high frequency impulses of stretch or strain on the membranes as the system 600 moves with an active fluid flow.

The support structure 630 can be coupled to the sensing elements 610 and/or the membranes 620 and configured to position the membranes 620 adjacent to an inner wall of the pipe 650. The support structure 630 can be a spring-loaded, umbrella-like structure that is configured to expand or compress to adapt to changes in pipe diameter and other obstacles or extrusions encountered in the pipe 650. For example, the support structure 630 can include support arms or shafts 632 that extend radially from a common hub 634. When a fluid flows in the pipe 650, the fluid flow can push the support structure 630 such that the radially extending support arms 632 expand and thereby maintain contact with the inner wall of the pipe 650 as the system 600 moves through the pipe. Conversely, when the system 600 encounters an obtrusion (e.g., pipe joint or other reduction in pipe diameter), the obtrusion and/or a fluid flow can push down on one or more the radially extending support arms 632, thereby compressing the support structure 630. One or more position encoders can be coupled to the support arms 632 to monitor the configuration of the support arms 632 as the support arms 632 extend or compress, and thus indicate the diameter change of the pipe 650 and the presence of obtrusions. The sensing elements 610 and/or the membranes 620 can be attached to the terminal ends 236 of the radially extending support arms 632.

The sensing elements 610 can be placed between the membrane 620 and the support structure 630 to measure the relative stretch or strain between the membrane 620 and the support structure 630 with the highest sensitivity. The membrane 620 can be disposed substantially parallel to or in-line with an axial direction of a fluid flow in a pipe 650 and the motion or displacement of the membrane 620 in the axial direction of the fluid flow is minimally hindered by the inertia of the fluid. So when the membrane 620 is pulled in the axial direction of the fluid flow, the membrane 620 can stretch or strain easily in the axial direction of the fluid flow. In contrast, the support structure 630 can be disposed substantially perpendicular to the axial direction of the fluid flow in the pipe 650, and the motion or displacement of the support structure 630 in the axial direction of the fluid flow is greatly hindered by the inertia of the fluid around the support structure 630. Therefore, the support structure 630 can move negligibly against the axial direction of the fluid flow when the pulling force on the membrane 620 is transferred to the support structure 630. When the sensing elements 610 are placed between the membrane 620 (which stretch or strain easily in the axial direction of the fluid flow) and the support structure 630 (which negligibly moves against the axial direction of the fluid flow), the sensing elements 610 can easily detect the relative stretch or strain between the membrane 620 and the support structure 630 even if a small pulling force is present on the membrane.

Although FIG. 6 illustrates only two membranes 620 and two sensing elements 610 extending from two radially extending arms 632, any number of membranes, sensing elements, and arms can be used without departing from the spirit of the present disclosure. The number of membranes 620, sensing elements 610, and radially extending support arms 632 can be selected to cover the entire circumference of a pipe cross-section for leak detection. For example, if each membrane 620 spans 90 degrees of a circle, the support structure 630 can include four radially extending arms 632 coupled to four sensing elements 610 and four membranes 620 to substantially cover each quadrant of the pipe cross-section. Each membrane 620 and sensing element 610 couple can be configured to detect leaks in a quadrant of the pipe cross section that the membrane 620 covers and indicate that the radial position of the leak is within that quadrant. The circumference of the pipe cross-section can be divided into more than four quadrants if more accurate radial position of the leak is desired. Likewise, optionally, additional membranes and sensing elements can be layered on top of another and/or placed in openings disposed between adjacent membranes to fill-in any gaps that can exist between membranes.

FIG. 7 is a schematic illustration of one exemplary embodiment of a coupling mechanism disposed between some combination of a sensing element 610 and membrane 620 and a support structure 630. As shown, a rigid slot structure 700 can be connected to a terminal end 636 of the radially extending arm 632. The rigid slot structure 700 can be configured to receive and loosely hold the membrane 620 and/or the sensing element 610 coupled thereto. The terminal end 636 of the radially extending arm 632 and the rigid slot structure 700 can be further configured to position the membrane 620 and the sensing element 610 placed inside the slot structure away from the inner wall of the pipe 650 at a substantially fixed distance or gap size H. The term substantially is used in this context, and in other contexts herein, as a person skilled in the art will recognize there can be a negligible amount of movement that can occur while the system 600 is traveling.

The gap size H between the membrane 620 and the inner wall can be configured to enable detection of small leaks, including small leaks in low pressure pipes. For example, with small leaks, the induced rapid pressure drop can be restricted within a small region near the leak. Accordingly, the gap size can be configured to maintain the membrane 620 and the sensing element 610 placed inside the slot at a substantially fixed distance that is as close as possible to the inner wall of the pipe 650 without contacting the wall. The gap size can depend on a variety of factors, including but not limited to a size and configuration of the pipe in which the system 600 is being used, a size and configuration of the various components used in the system 600, a flow rate, a low line pressure amount, and a size of possible known obstacles, defects, and leaks. Additionally, to the extent the gap size is designed to be a fixed distance, a person skilled in the art will recognize that the gap size can change in use as the system 600 moves through a pipe. Such movement is understood to be encompassed by the designed gap size (e.g., a gap size of approximately 2 mm can vary above and below that gap size a reasonable amount, such as about 0.1 mm, 0.2 mm, etc.). A gap size H can be approximately in the range of about 0.5 mm to about 5 mm, and in some exemplary embodiments the gap size H is about 2 mm to detect leaks caused by holes having an average diameter size of approximately 4 mm and having a low line pressure approximately in the range of about 0.8 bars to about 2 bars. Other gap sizes and pressures can also be used without departing from the spirit of the present disclosure.

To create the gap, the terminal end 636 of the radially extending support arm 632 can be bent. For example, FIG. 7 shows the terminal end 636 of the support arm 632 having a bend that is approximately 90 degrees, although other angle ranges are possible. Accordingly, when the support structure 630 is in its expanded state, a peak of a bend 702 can be in direct contact with the inner wall as the system 600 moves with the active flow through the pipe 650. Thus, the gap size H can be configured to be the distance between the peak of the bend 702 and the rigid slot structure 700 plus the thickness of the top of the rigid slot structure 700 that is adjacent to the inner wall.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of locating a robot in a conduit, comprising:
obtaining acceleration data of a robot travelling through a conduit;
obtaining timestamps associated with a plurality of obtrusions detected in the conduit by the robot;
identifying one or more groups of consecutive obtrusions among the plurality of obtrusions detected in the conduit, wherein each of the one or more groups includes a plurality of consecutive obtrusions having substantially equal time delays therebetween;
determining an average speed of the robot between the plurality of consecutive obtrusions in each of the one or more groups;
determining a plurality of instantaneous speed values of the robot between the plurality of consecutive obtrusions in each of the one or more groups based on the acceleration data of the robot and the average speed of the robot between the plurality of consecutive obtrusions in each group; and
determining a distance traveled by the robot by integrating the plurality of instantaneous speed values.

2. The method of claim 1, wherein the one or more groups of consecutive obtrusions detected in the conduit include a first group of consecutive obtrusions and a second group of consecutive obtrusions.

3. The method of claim 2, further comprising:
determining a plurality of instantaneous speed values of the robot between the first group of consecutive obtrusions and the second group of consecutive obtrusions based on the acceleration data, a first instantaneous speed value of the robot determined at an end of the first group, and a second instantaneous speed value determined at a beginning of the second group; and
determining a distance traveled by the robot between the end of the first group of consecutive obtrusions and the beginning of the second group of consecutive obtrusions by integrating the plurality of instantaneous speed values of the robot determined between the first group and the second group.

4. The method of claim 1, further comprising:
measuring a discrete instantaneous speed value of the robot at each of the plurality of obtrusions in the conduit; and
determining the plurality of instantaneous speed values of the robot between the plurality of consecutive obtrusions in each of the one or more groups based on the acceleration data, the average speed of the robot determined between the plurality of consecutive obtrusions in each group, and the discrete instantaneous speed value measured at each of the plurality of consecutive obtrusions in each group.

5. The method of claim 2, further comprising:
measuring a discrete instantaneous speed value of the robot at each of the plurality of obtrusions detected in the conduit; and
determining a plurality of instantaneous speed values of the robot between the first group of consecutive obtrusions and the second group of consecutive obtrusions based on the acceleration data, a first discrete instantaneous speed value of the robot measured at an end of the first group, and a second discrete instantaneous speed value of the robot measured at a beginning of the second group, and one or more discrete instantaneous speed values measured at one or more obtrusions detected between the first group and the second group.

6. The method of claim 1, wherein the conduit is a water pipe system and the plurality of consecutive obtrusions are consecutive pipe joints disposed between consecutive pipe segments having a substantially fixed length.

7. The method of claim 6, wherein determining the average speed of the robot between the plurality of consecutive obtrusions in each of the one or more groups comprises dividing the substantially fixed length of the consecutive pipe segments by a time delay measured between one or more pairs of consecutive pipe joints in each group.

8. The method of claim 1, further comprising detecting the plurality of obtrusions in the conduit using a tactile sensor associated with the robot.

9. The method of claim 1, further comprising:
obtaining directional data of the robot travelling through the conduit; and
determining a location of the robot in the conduit based on the directional data and the determined distance travelled by the robot.

10. A system of locating a robot in a conduit, comprising:
a robot configured to travel through a conduit;
at least one tactile sensor associated with the robot and configured to detect obtrusions in the conduit; and
a processor coupled to the sensor and configured to:
obtain acceleration data of a robot travelling through the conduit;
obtain timestamps associated with a plurality of obtrusions detected in the conduit by the robot;
identify one or more groups of consecutive obtrusions among the plurality of obtrusions detected in the conduit, wherein each of the one or more groups includes a plurality of consecutive obtrusions having substantially equal time delays therebetween;
determine an average speed of the robot between the plurality of consecutive obtrusions in each of the one or more groups;
determine a plurality of instantaneous speed values of the robot between the plurality of consecutive obtrusions in each of the one or more groups based on the acceleration data and the average speed of the robot between the plurality of consecutive obtrusions in each group; and
determine a distance traveled by the robot by integrating the plurality of instantaneous speed values.

11. The system of claim 10, wherein the one or more groups of consecutive obtrusions detected in the conduit include a first group of consecutive obtrusions and a second group of consecutive obtrusions.

12. The system of claim 11, wherein the processor is further configured to:
determine a plurality of instantaneous speed values of the robot between the first group of consecutive obtrusions and the second group of consecutive obtrusions based on the acceleration data, a first instantaneous speed value of the robot determined at an end of the first group, and a second instantaneous speed value determined at a beginning of the second group; and
determine a distance traveled by the robot between the end of the first group of consecutive obtrusions and the beginning of the second group of consecutive obtrusions by integrating the plurality of instantaneous speed values of the robot determined between the first group and the second group.

13. The system of claim 11, wherein the processor is further configured to:
measure a discrete instantaneous speed value of the robot at each of the plurality of obtrusions detected in the conduit; and
determine a plurality of instantaneous speed values of the robot between the first group of consecutive obtrusions and the second group of consecutive obtrusions based on the acceleration data, a first discrete instantaneous speed value of the robot measured at an end of the first group, and a second discrete instantaneous speed value of the robot measured at a beginning of the second group, and one or more discrete instantaneous speed values measured at one or more obtrusions detected between the first group and the second group.

14. The system of claim 10, wherein the processor is further configured to:
measure a discrete instantaneous speed value of the robot at each of the plurality of obtrusions in the conduit; and
determine the plurality of instantaneous speed values of the robot between the plurality of consecutive obtrusions in each of the one or more groups based on the acceleration data, the average speed of the robot determined between the plurality of consecutive obtrusions in each group, and the discrete instantaneous speed value measured at each of the plurality of consecutive obtrusions in each group.

15. The system of claim 10, wherein the conduit is a water pipe system and the plurality of consecutive obtrusions are consecutive pipe joints disposed between consecutive pipe segments having a substantially fixed length.

16. The system of claim 15, wherein to determine the average speed of the robot between the plurality of consecutive obtrusions in each of the one or more groups the processor is further configured to divide the substantially fixed length of the consecutive pipe segments by a time delay measured between one or more pairs of the consecutive pipe joints in each group.

17. The system of claim 10, wherein the processor is further configured to:
obtain directional data of the robot travelling through the conduit; and
determine a location of the robot in the conduit based on the directional data and the determined distance travelled by the robot.

18. A robot, comprising:
a body portion;
at least one tactile sensor disposed on the body portion and configured to detect obtrusions in a conduit; and
a processor coupled to the sensor and configured to:
obtain acceleration data of the robot travelling through the conduit;
obtain timestamps associated with a plurality of obtrusions detected in the conduit by the at least one tactile sensor;
identify one or more groups of consecutive obtrusions among the plurality of obtrusions detected in the conduit, wherein each of the one or more groups includes a plurality of consecutive obtrusions having substantially equal time delays therebetween;
determine an average speed of the robot between the plurality of consecutive obtrusions in each of the one or more groups;
determine a plurality of instantaneous speed values of the robot between the plurality of consecutive obtrusions in each of the one or more groups based on the acceleration data and the average speed of the robot between the plurality of consecutive obtrusions in each group; and
determine a distance traveled by the robot by integrating the plurality of instantaneous speed values.

19. The robot of claim 18, wherein the processor is further configured to:
determine a plurality of instantaneous speed values of the robot between a first group of consecutive obtrusions and a second group of consecutive obtrusions based on the acceleration data, a first instantaneous speed value of the robot determined at an end of the first group, and a second instantaneous speed value determined at a beginning of the second group; and
determine a distance traveled by the robot between the end of the first group of consecutive obtrusions and the beginning of the second group of consecutive obtrusions by integrating the plurality of instantaneous speed values of the robot determined between the first group and the second group.

20. The robot of claim19, wherein the processor is further configured to:
measure a discrete instantaneous speed value of the robot at each of the plurality of obtrusions detected in the conduit; and
determine the plurality of instantaneous speed values of the robot between the plurality of consecutive obtrusions in each of a plurality of groups of consecutive obtrusions based on the acceleration data, the average speed of the robot determined between the plurality of consecutive obtrusions in each group, and the discrete instantaneous speed value measured at each of the plurality of consecutive obtrusions in each of a plurality of groups;
determine a plurality of instantaneous speed values of the robot between the plurality of groups of consecutive obtrusions based on the acceleration data, a first discrete instantaneous speed value of the robot measured at an end of a first group among the plurality of groups, a second discrete instantaneous speed value of the robot measured at a beginning of a second group among the plurality of groups, and one or more discrete instantaneous speed values measured at one or more obtrusions detected between the first group and the second group.
